(19) United States
(12) Patent Application Publication
(10) Pub. No.: US 2017/0169733 A1
(43) Pub. Date: Jun. 15, 2017

(54) MODULAR SURGICAL SIMULATION TRAINER AND METHODS OF USE

(71) Applicants: The Texas A&M University System, College Station, TX (US); University of Connecticut, Farmington, CT (US); Connecticut Children's Medical Center, Hartford, CT (US)

(72) Inventors: Donald Russell Peterson, Texarkana, TX (US); Simon Kudernatsch, Texarkana, TX (US); Tulio Alberto Valdez, Simsbury, CT (US)

(21) Appl. No.: 15/380,609

(22) Filed: Dec. 15, 2016

Related U.S. Application Data
(60) Provisional application No. 62/267,616, filed on Dec. 15, 2015.

(51) Int. Cl. G09B 23/30; B29C 67/00; B33Y 80/00; B29C 33/38; B33Y 10/00; G09B 9/00; B29C 39/00

(52) U.S. Cl. CPC G09B 23/30; G09B 9/00; B29C 67/0051; B29C 39/003; B29C 33/3842; B33Y 10/00; B33Y 80/00; B29K 2083/00

(57) ABSTRACT

The invention is directed to a modular surgical simulation trainer that makes use of anatomic surrogates placed within a housing to simulate a wide variety of various medical conditions including various laryngeal and tracheal pathological conditions. The anatomic surrogates exhibit tissue like properties and resemble healthy tissue or pathological tissue.

### CROSS-REFERENCES TO RELATED APPLICATIONS

This application claims priority to and incorporates by reference the entire disclosure of U.S. Provisional Patent Application No. 62/267,616 filed on Dec. 15, 2015.

### BACKGROUND OF THE INVENTION

Simulation training has become an integral part of medical education and residency training. It is essential for residents and doctors-in training to have access to appropriate models and equipment to use in simulation sessions to prepare for real life situations encountered in the operating room. Currently, there are no models of the upper airway available commercially to otolaryngology residents. Successful management of a critical airway in otolaryngology depends on the dexterity of the surgeon in being able to manipulate the airway, familiarity of the equipment, and proper communication with the anesthesia team and the operating room staff. However, critical airway cases can be rare, providing otolaryngology residents with few opportunities to familiarize themselves with challenging airway cases. Therefore, alternative training must be provided, and simulation is an attractive option. Currently there are no surgical trainers on the market that provide a means for practicing incising and suturing on common laryngeal, epiglottal, and/or tracheal conditions. The complexity of these models is believed to be the primary contributing factor for the lack of such a training device. Additionally, due to the inaccessibility of training and experience, only an very small group of surgeons exist in the US and abroad who possess the appropriate skills needed to effectively perform procedures in this part of the body.

### SUMMARY OF THE INVENTION

The modular surgical simulation trainer of the claimed invention makes use of anatomic surrogates placed within a housing to simulate a wide variety of various medical conditions including various laryngeal and tracheal pathological conditions. By making use of 3D-printing, anatomical structures can be produced with relative ease, allowing the possibility of medical scans of patients to be simulated by the trainer.

Anatomic surrogates are produced by first designing an anatomic mold with the desired properties. After the anatomic mold is printed, a tissue surrogate is cast inside of the anatomic mold. An aspect of the invention is directed to a method for creating anatomic surrogates comprising 3D printing an anatomic mold; and casting the tissue surrogate material into the anatomic mold.

### BRIEF DESCRIPTION OF THE DRAWINGS

FIGS. 1A, 1B, 1C, 1D, 1E and 1F show the various pathologies created with silicone elastomer surgical surrogates in accordance with an embodiment of the invention;

FIGS. 2A and 2B shows the manipulation of a laryngeal cleft model in accordance with an embodiment of the invention;

FIGS. 3A and 3B shows the incision of a subglottic stenosis using a sickle knife in accordance with an embodiment of the invention; and

FIG. 4 shows a pictorial representation of a anatomical surrogate for a trachea in accordance with an embodiment of the invention.

### DESCRIPTION OF EXEMPLARY EMBODIMENTS

Embodiments of the claimed invention are directed to a modular system for simulating complex organs such as the tracheoesophageal and laryngeal complex, comprising a position-adjustable housing, where interchangeable anatomic surrogates are placed and secured by the housing, and in certain embodiments, the housing may be mounted on a platform. In certain embodiments, the housing is mounted using ball and socket joints, which enables the angle of the housing and accompanying organ surrogate to be adjusted for proper positioning prior to initiating surgical training protocols.

Correct placement of anatomic surrogates within the housing is made certain by the outer shapes of the anatomic structures which prevent them from being placed incorrectly. The position adjustable housing also enables the system to be modular, meaning that different organ surrogates can be attached to the housing as needed for any surgical simulation. In certain embodiments, the housing holds two anatomical inserts: one laryngeal and one tracheal. In certain embodiments the housing is made from Fused Deposition Modelling (FDM) 3D printing. In other embodiments, the housing may be made by injection molding.

In an embodiment of the invention directed to a method of creating anatomic surrogates utilizing high-performance tissue surrogates, the tissue surrogate is casted into sophisticated 3D-printed anatomic molds made of plastic, which are designed using computer aided design (CAD) software to exhibit certain medical conditions (the molds created via FDM). In some embodiments, anatomic surrogates may be modeled after healthy models or diseased and pathological models. In other embodiments, anatomic surrogates may be generated from medical imaging, such as an MRI, to provide pre-operative patient specific training. In certain embodiments, the surrogates may be made from silicone elastomers and exhibit tissue like properties and resemble various medical conditions such as laryngeal clefts, laryngomalacia, and subglottic and tracheal stenosis or cysts. In certain embodiments, sensors, such as low-cost high resolution micro-cameras and/or contact sensors, may be utilized to provide user and teacher feedback.

In an embodiment of the invention is directed to a modular surgical simulation trainer comprising anatomic surrogates placed in a housing. In certain embodiments, the housing is position-adjustable. In certain embodiments, the housing is comprised of 3D printed plastic. In certain embodiments, the housing is mounted on a platform wherein the angle of the housing can be adjusted using ball and socket joints mounted on the platform. In certain embodiments of the invention, the anatomic surrogate is comprised of silicone elastomers.

An embodiment of the method is directed to creating anatomic surrogates comprising 3D printing an anatomic mold and casting the tissue surrogate material into the anatomic mold. In some embodiments, the anatomic mold is printed using fused deposition modeling. In certain embodiments the anatomic mold is modelled on healthy medical conditions. In other embodiments, the anatomic mold is modelled on pathological medical conditions.

In an embodiment of the invention, additive manufacturing, or 3D printing, is used to create anatomic surrogates. In the 3D printing process, an object is built by repetitively adding material layers atop of each layer until a given object is completed. The individual layers represent discretization of the said object into a multitude of two dimensional cross-sections, where each layer corresponds to one cross-section.

In an embodiment of the invention, the Fused Deposition Modeling process is used to create anatomic surrogates. In this process, a thermoplastic material is forced through a heated nozzle that traces the inner and outer outlines of each cross-section and completes the layer by filling material in between. As the thermoplastic material cools down, it fuses with the previously deposited layers, thus giving the rise to the name Fused Deposition Modeling.

In certain embodiments, virtual models are created using Computer Aided Design (CAD) software and 3D printing technology to develop surgical surrogates of healthy larynx and four upper airway conditions; laryngomalacia, laryngeal cleft, subglottic cyst, and subglottic. Four different material candidates, including Acrylonitrile Butadiene Styrene (ABS), High Impact Polystyrene (HIPS), Polylactic Acid (PLA), and Silicone Elastomer (SE), were evaluated for hardness, while Shore Hardness was reported based on manufacturer data. Although ABS and PLA are hard materials by nature, minimal wall thickness that would render the surrogates flexible was explored. All surrogates were visually assessed for anatomic accuracy and evaluated for realistic and tissue-like behavior during simulated procedure by an otolaryngology specialist. Estimated manufacturing time was also reported for each model.

A normal pediatric larynx and four other pediatric airway conditions (i.e., laryngomalacia, laryngeal cleft, subglottic cyst, and subglottic stenosis) were successfully created using 3D printing technology. ABS, HIPS, PLA, and SE were used as manufacturing materials. Shore Hardness, or the resistance to indentation using various indentation tools (represented by a suffix after the numerical value), was reported for each material in Table 1 and a Shore Hardness scale of various household materials is provided in Table 2 as a point reference.

TABLE 1
Shore Hardness Scale values of silicone rubber used in 3D printing.

| Material | Shore Hardness |
|---|---|
| ABS | 75 D |
| HIPS | 50 A |
| PLA | 80 D |
| SE | 10 A |

TABLE 2
Shore Hardness Scales of household materials

| | | | | | | | | Medium | | Medium | | | | | | | | |
|---|---|---|---|---|---|---|---|---|---|---|---|---|---|---|---|---|---|---|
| | Extra soft | | | | Soft | | | Soft | | Hard | | Hard | | Extra Hard | | | | |
| Shore 00 | 0 | 10 | 20 | 30 | 40 | | 50 | 60 | 70 | 80 | | 90 | | 100 | | | | |
| Shore A | | | | | | 0 | 10 | 20 | 30 | 40 | 50 | 60 | 70 | | 80 | 90 | | 100 |
| Shore D | 70 | | 80 | 90 | | | 100 | | | | | 0 | 10 | 20 | 30 | 40 | 50 | 60 |

| | | | | | | |
|---|---|---|---|---|---|---|
| Household | Gummy | gel sole | rubber band | eraser | tire tread | shoe heel |
| items | hard hat | | | | | |
| | candy | | | | | |

The PLA and ABS were classified as “extra hard” on the Shore D Hardness scale in Table 2 (similar to a hard hat material), while HIPS was classified as “medium soft” on the Shore A scale (comparable to pencil eraser) and SE was classified as “soft,” which is similar to a rubber band on the Shore A scale.

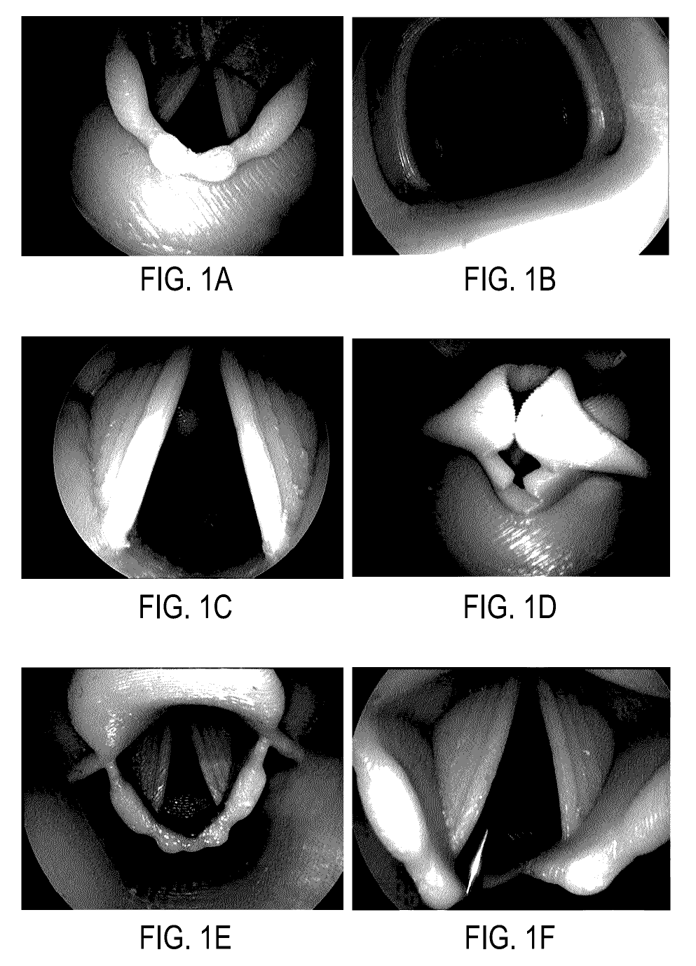

At any thickness, the models created using PLA and ABS materials were rigid and impossible to incise or suture, while the models made with HIPS material were stiff, difficult to suspend for direct laryngoscopy, and very resilient to incising or suturing. However, the SE models were amenable to manipulation in direct laryngoscopy with realistic tissue-like reactions including epiglottal lift when an upward force was applied with the laryngoscope in the vallecula. These models were also amendable to being easily incised for a supraglottoplasty, being dilated for a subglottic stenosis, and being sutured for a laryngeal cleft. Independent of manufacturing material, all surrogates possessed the same high degree of anatomic accuracy. The details of the SE surrogates that were recorded with an endoscopic camera are shown in FIGS. 1A-1F. FIG. 1A shows a normal larynx, FIG. 1B shows a normal trachea, FIG. 1C shows a subglottic cyst, FIG. 1D shows a laryngomalacia, FIG. 1E shows a subglottic stenosis, and FIG. 1F shows a laryngeal cleft.

The ABS diseased surrogate conditions required on average 44.16 g of material. Both, the HIPS and the PLA surrogates required average 43.28 g, while the SE surrogates required on average 104.19 g. The averaged estimated time to manufacture the ABS diseased surrogate conditions was 2.86 hours and for, both, the HIPS and the PLA surrogates 2.83 hours. The SE surrogates took on average 0.50 hours to manufacture. The complete cost, material, and time analysis for diseased surrogate conditions is presented in Table 3. For comparison, the cost, material, and time analysis of the normal larynx and normal trachea surrogate is presented in Table 4.

TABLE 3
Summary of cost, material, and time analysis for each of the laryngeal conditions.

| | Upper Airway Surgical Surrogates | | | | | |
|---|---|---|---|---|---|---|
| Material | Laryngomalacia | Laryngeal Cleft | Subglottic Cyst | Subglottic Stenosis | Mean | STD |

Acrylonitrile Butadien Styrene (ABS, $0.048/g)

| | | | | | | |
|---|---|---|---|---|---|---|
| Est. Time (hrs) | 2.87 | 2.82 | 2.88 | 2.88 | 2.86 | 0.03 |
| Material (g) | 43.37 | 43.97 | 44.54 | 44.76 | 44.16 | 0.54 |
| Price ($) | 2.08 | 2.11 | 2.14 | 2.15 | 2.12 | 0.03 |

High Impact Polystyrene (HIPS, $0.107/g)

| | | | | | | |
|---|---|---|---|---|---|---|
| Est. Time (hrs) | 2.83 | 2.78 | 2.85 | 2.85 | 2.83 | 0.03 |
| Material (g) | 42.49 | 43.08 | 43.66 | 43.87 | 43.28 | 0.54 |
| Price ($) | 4.56 | 4.63 | 4.69 | 4.71 | 4.65 | 0.06 |

Polylactic Acid (PLA, $0.053/g)

| | | | | | | |
|---|---|---|---|---|---|---|
| Est. Time (hrs) | 2.83 | 2.78 | 2.85 | 2.85 | 2.83 | 0.03 |
| Material (g) | 42.49 | 43.08 | 43.66 | 43.87 | 43.28 | 0.54 |
| Price ($) | 2.27 | 2.30 | 2.33 | 2.34 | 2.31 | 0.03 |

Silicon Rubber (Dragon Skin, $0.066/g)

| | | | | | | |
|---|---|---|---|---|---|---|
| Est. Time (hrs) | 0.50 | 0.50 | 0.50 | 0.50 | 0.50 | 0.00 |
| Material (g) | 103.18 | 104.44 | 104.04 | 105.09 | 104.19 | 0.69 |
| Price ($) | 6.85 | 6.93 | 6.90 | 6.97 | 6.91 | 0.05 |

TABLE 4
Summary of cost, material, and time analysis for healthy
Larynx and Trachea

Upper Airway Surgical Surrogates

| | | |
|---|---|---|
| Material | Normal Larynx | Normal Trachea |

Acrylonitrile Butadien Styrene (ABS, $0.048/g)

| | | |
|---|---|---|
| Est. Time (hrs) | 2.87 | 2.47 |
| Material (g) | 44.33 | 36.31 |
| Price ($) | 2.13 | 1.94 |

High Impact Polystyrene (HIPS, $0.107/g)

| | | |
|---|---|---|
| Est. Time (hrs) | 2.82 | 2.47 |
| Material (g) | 43.39 | 36.38 |
| Price ($) | 4.66 | 1.75 |

Polylactic Acid (PLA, $0.053/g)

| | | |
|---|---|---|
| Est. Time (hrs) | 2.82 | 2.47 |
| Material (g) | 43.39 | 36.31 |
| Price ($) | 2.31 | 3.90 |

Silicon Rubber (Dragon Skin, $0.066/g)

| | | |
|---|---|---|
| Est. Time (hrs) | 0.50 | 0.50 |
| Material (g) | 103.76 | 69.90 |
| Price ($) | 6.89 | 4.64 |

Utilizing 3D printing technology generates a low-cost and highly repeatable process with a high degree of anatomic accuracy in creation of the surgical surrogates, where it provides realistic models for simulation in resident teaching sessions. These models can be made based on number of different pathologies utilizing varying hardnesses of available materials. From the tested materials, the harder (ABS, HIPS, and PLA) surrogates were difficult to be surgically manipulated at any thickness, while the SE surrogates were the most pliable and most resembled natural tissues present in the upper airway. The SE surgical surrogates were able to closely mimic anatomy of the normal larynx, laryngomalacia, laryngeal clefts, and subglottic stenosis while corresponding appropriately to surgical manipulation. The SE surgical models reacted to the forces applied in a direct laryngoscopy much like natural tissues would, where different structures could be grasped and moved, the model can be incised with a scalpel, cut with laryngeal micro-scissors, sutured with standard sutures, and dilated with balloons.

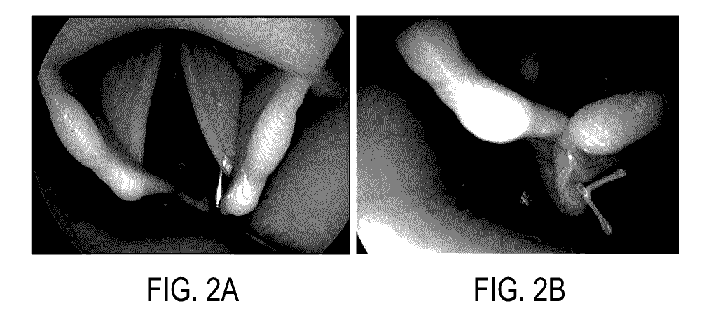

An embodiment of the claimed invention is directed to the manipulation of an anatomic surrogate model. FIG. 2A shows the manipulation of a laryngeal cleft using a right angle hook. FIG. 2B shows a laryngeal cleft being sutured using a 4.0 vicryl suture.

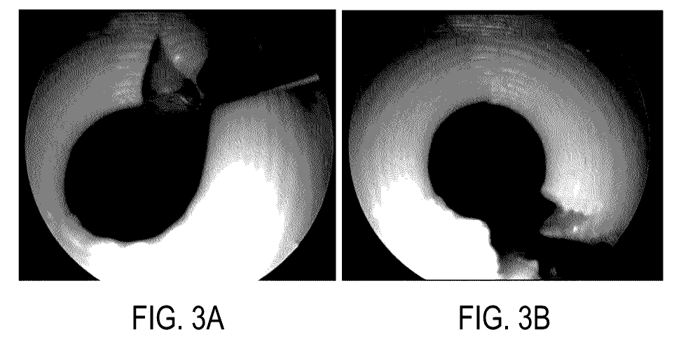

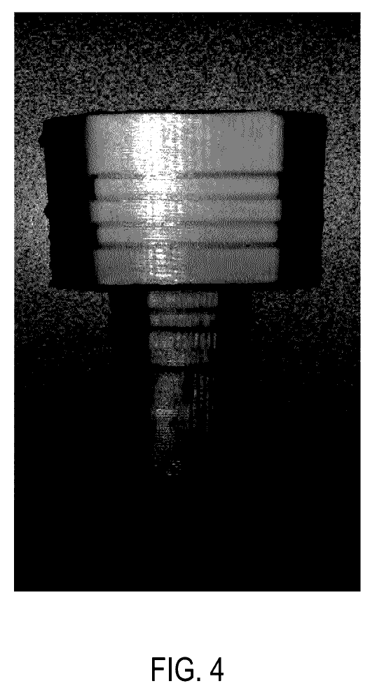

FIGS. 3A and 3B shows the incision of a subglottic stenosis. Overall, the SE surgical surrogate delivers a very realistic feel, and would be the most suitable in upper airway simulation scenarios. FIG. 4 shows a pictorial representation of the disclosed invention.

Although the harder materials (i.e., ABS, PLA and HIPS) are more cost efficient, their material properties at any thickness do not make them suitable to be used in laryngeal surgical simulation. These materials and surrogates would be better suited for simulation scenarios where close imitating of tissue characteristics is not required. Overall, SE surrogates are more expensive but have a superior ability to better mimic natural tissue structures.

The application of 3D printing technology and use of multiple common materials in creation of low-cost surgical surrogates for pediatric laryngeal surgical simulation were explored and, while all materials used provided a realistic anatomic representation of the upper airways, only the SE surrogates were able mimic natural tissues correctly and can responded appropriately when surgically manipulated. The claimed method is not limited to pediatric otolaryngology but has a wide application potential in whole spectrum of surgical simulation.

Conditional language used herein such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. While the above detailed description has shown, described, and pointed out novel features as applied to various embodiments, it will be understood that various omissions, substitutions, and changes in the form and details of the devices illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

What is claimed is:

1. A modular surgical simulation trainer comprising anatomic surrogates placed in a housing.

2. The modular surgical simulation trainer of claim 1, wherein the housing is position-adjustable.

3. The modular surgical simulation trainer of claim 1, wherein the housing is comprised of 3D printed plastic.

4. The modular surgical simulation trainer of claim 1, wherein the housing is mounted on a platform.

5. The modular surgical simulation trainer of claim 1, wherein the housing is mounted on the platform using a ball and socket joint.

6. A modular surgical simulation trainer according to claim 5, wherein the angle of the housing can be adjusted using the ball and socket joints mounted on the platform.

7. A modular surgical simulation trainer according to claim 1, wherein the anatomic surrogate is comprised of silicone elastomers.

8. A method for creating anatomic surrogates comprising:
3D printing an anatomic mold; and
casting the tissue surrogate material into the anatomic mold.

9. The method of claim 8 wherein the anatomic mold is printed using fused deposition modeling.

10. The method of claim 8 wherein the surrogate material is comprised of silicone elastomers.

11. The method of claim 8 wherein the anatomic mold is modelled on a healthy organ or tissue.

12. The method of claim 8, wherein the anatomic mold is modelled on a pathological or disease condition.

13. The method of claim 8, wherein the tissue surrogate material is a silicone elastomer.

14. The method of claim 11, wherein the anatomic mold is modelled on a healthy larynx.

15. The method of claim 12, wherein the anatomic mold is modelled on disease conditions selected from laryngomalacia, laryngeal cleft, subglottic cyst, and subglottic.
